(19) United States
(12) Patent Application Publication
(10) Pub. No.: US 2008/0091979 A1
(43) Pub. Date: Apr. 17, 2008

(54) SEMICONDUCTOR MEMORY DEVICE AND TEST METHOD

(76) Inventor: Yuichi OKUDA, Higashimurayama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/951,866

(22) Filed: Dec. 6, 2007

Related U.S. Application Data
(62) Division of application No. 10/767,054, filed on Jan. 30, 2004.

(30) Foreign Application Priority Data
Jan. 31, 2003 (JP) 2003-023019

(51) Int. Cl. G06F 11/07

(52) U.S. Cl. 714/42; 714/E11.024

(57) ABSTRACT

A semiconductor device includes memory mats each including a plurality of memory cells to store information code or error correcting code. An error correcting circuit corrects an error of the information code by one correction unit of a predetermined number of information codes. A parallel test mode activates and tests the memory mats simultaneously with a different function from a normal read or write function. Parallel decision circuits are coupled between the error correcting circuit and the memory mats, and are activated during the test mode. The parallel test circuits detect a one bit information code defect by the correction unit during the parallel test mode.

### CROSS-REFERENCE TO RELATED APPLICATIONS

This application is a divisional of U.S. application Ser. No. 10/767,054, filed Jan. 30, 2004, and which application claims priority from Japanese patent application No. 2003-023019, filed on Jan. 31, 2003, the entire contents of which are hereby incorporated by reference into this application.

### BACKGROUND OF THE INVENTION

The present invention relates to a semiconductor memory device and to a test method thereof. The present invention relates mainly to a technique that is effective when applied to a dynamic random access memory device having an ECC circuit mounted thereon, and to a test facilitation technique thereof.

Japanese Unexamined Patent Publication No. Hei 11(1999)-025689 discloses an example of a semiconductor memory device test method and a semiconductor memory device which has an ECC circuit mounted thereon and which is provided with means for deciding whether no errors, a 1-bit error, or an error with 2 bits or more occurs, and operates on the basis that there is no problem of using the tested device as a non-defective product even when it includes a 1-bit hard error.

[Patent Document 1]

Japanese Unexamined Patent Publication No. Hei 11 (1999)-025689

### SUMMARY OF THE INVENTION

As described in Patent Document 1, on the assumption that the ECC decoder mounted in the semiconductor memory device is normal, regarding an information bit and a check bit as one information bit, an ECC generator for testing is added thereto, and an error correction signal formed by the ECC decoder is compared with write data WD corresponding to the inputted information bit and test data TD serving as a check bit to detect a defect of 2 bits or more.

The technique of Patent Document 1 requires, as the ECC decoder, a circuit for forming read data RD by an information bit and a check bit for normal operation and a circuit for forming an information bit and a check bit error-corrected by a check bit generated by the ECC generator for testing, regarding an information bit and a check bit as one information bit, for the test operation, and the ECC generator for testing. It also requires an input circuit for inputting the test data TD for testing and an output circuit for outputting the check bit. However, the circuit size of the ECC decoder, the ECC generator for testing, the input circuit and the output circuit, which are used only for testing, is increased. Along with this drawback, the number of external terminals is increased, and any defects in the ECC decoder cannot be precisely detected. Since any defective locations cannot be specified, a redundancy circuit for switching a defective cell to a preliminary cell cannot be used.

To shorten the time for defect selection, in a DRAM having a large memory capacity, it is typical to employ a test method called a parallel test, which tests a number of bits in parallel. In Patent Document 1, however, no consideration is given to a parallel test for shortening the test time. When this method is applied to a DRAM as-is, the test time is longer so that an increase in the test cost will reflect directly on the product cost.

An object of the present invention is to provide a semiconductor memory device on which an ECC circuit is mounted, and which enables an efficient test with high accuracy using a simplified structure, and a test method thereof.

Another object of the present invention is to provide a semiconductor memory device incorporating an ECC that is capable of shortening the test time using a simplified structure, and a test method thereof.

The above and other objects and novel features of the present invention will be apparent from the description provided in this specification and from accompanying drawings.

A representative example of the present invention will be simply described as follows. A semiconductor memory device has an ECC circuit that is capable of correcting, from an m-bit information code and an n-bit check code that are stored in an information storing part, an error of the information code to x bits, and a parallel test circuit for receiving an information code and a check code for testing with the same bits that are stored in the information storing part, whereby a chip with a defect with the x+1 bits or more is determined as being defective.

Another representative example of the present invention will be simply described as follows. A test method of a semiconductor memory device having an ECC circuit capable of correcting, from an m-bit information code and an n-bit check code stored in an information storing part, an error of the information code, to x bits, and a test circuit for receiving an information code and a check code in the information storing part, wherein an information code and a check code for testing with the same bits are stored in the information storing part, the stored information code and check code for test are transmitted to the test circuit, and a device having a defect of x+1 bits or more for one piece of position information is determined as being defective.

### BRIEF DESCRIPTION OF THE DRAWINGS

FIG. is a block diagram showing an embodiment of a DRAM to which the present invention is applied;

FIG. 2 is a schematic circuit diagram showing an embodiment of a 6-bit input parallel decision circuit according to the present invention;

FIG. 3 is a schematic circuit diagram showing an embodiment of a parallel test decision circuit according to the present invention;

FIG. 4 is a schematic circuit diagram showing an embodiment of a pseudo independent decision circuit according to the present invention;

FIG. 5 is a block diagram showing an embodiment of a parallel test decision circuit when employing an ECC with 128+8 bits according to the present invention;

FIG. 6 is a block diagram showing data flow during normal operation of a semiconductor memory device according to the present invention;

FIG. 7 is a block diagram showing data flow when allowing memory cells for parity of a semiconductor memory device according to the present invention to be controllable;

FIG. 8 is a block diagram showing data flow when allowing the memory cells for parity according to the present invention to be observable;

FIG. 9 is a block diagram showing an example of the layout of the DRAM according to the present invention;

FIG. 10 is an overall block diagram showing an embodiment of a dynamic RAM according to the present invention; and

FIG. 11 is a schematic circuit diagram showing an embodiment of a DRAM according to the present invention.

### DETAILED DESCRIPTION OF THE PREFERRED EMBODIMENTS

FIG. 1 shows a block diagram of an embodiment of a DRAM according to the present invention. The circuit blocks in the drawing are formed on one semiconductor substrate by a known semiconductor integrated circuit manufacturing technique. The numeral 100 denotes a DRAM chip employing an ECC according to the present invention. Although the invention is not particularly so limited, a 16-pin chip based on the DDR SDRAM standards will be considered, and an ECC capable of correcting a 1-bit error by adding 4-bit parity for each 8-bit data is used.

In the DRAM chip 100, the numerals 101_0 to 101_3 denote a memory mat. The DRAM chip 100 further includes a row address decoder 102; a column address decoder 103; a command decoder 104; a register 105; a parity generation circuit 106; a parallel test selector 107; an ECC decoder 108; a parallel test decision circuit 109; decision result selectors 110_0 to 110_3; data pins 111_0 to 111_15; a command and address pin 112; a pseudo independent decision circuit 113; an input/output bus 120; parity data line 121; a global I/O bus 122; memory mat select signal lines 123_0 to 123_3; a row select signal line 124; a column select signal line 125; a command and address signal line 126; and main amp output signal lines 127_0 to 127_3. Counted to the DRAM chip 100 are test pins 130 of the memory tester. In an actual device there are a number of the command and address pins 112. In describing this embodiment, they need not be particularly discriminated, and so only one of them is shown.

The writing operation of the DRAM chip 100 employing the ECC in FIG. 1 is performed by the following operations 1) to 5).

1) A row address specification command is inputted to the command and address pin 112 with a row address and a memory mat select signal.

2) The row address decoder 102 outputs the row select signal 124 to activate a specified row of the memory mat specified by the command decoder 104.

3) A write command is inputted to the command and address pin 112 with a column address and a memory mat select signal to input data to the data pins 111.

4) Since the DRAM chip 100 employs the ECC, the 8-bit parity data 121 is generated by the parity generation circuit 106 from the inputted 16-bit data. The parallel test selector 107 selects data of 16 bits and parity of 8 bits and operates to output them to the global I/O bus 122 (24 bits).

5) The column address decoder 103 outputs the column select signal 125. The data of the global I/O bus 122 is written into the memory cell, according to the column select signal 125, in the memory mat specified by the command decoder 104.

The reading operation of the DRAM chip 100 employing the ECC in FIG. 1 is performed by the following operations 1) to 5).

1) A row address specification command is inputted to the command and address pin 112 with a row address and a memory mat select signal.

2) The row address decoder 102 outputs the row select signal 124 to activate a specified row of the memory mat specified by the command decoder 104 so as to amplify the contents of the memory cells in the sense amp in the memory mat 101.

3) A write command is inputted to the command and address pin 112 with a column address and a memory mat select signal.

4) The column address decoder 103 outputs the column select signal 125. Data is selected from the main amp output signal according to the column select signal 125 in the memory mat specified by the command decoder 104 so as to be finally amplified in the main amp. The main amp output signal 127 is outputted to the global I/O bus 122.

5) Since the DRAM chip 100 employs an ECC, the main amp output has 24 bits obtained by adding parity of 8 bits to data of 16 bits. The ECC decoder 108 corrects the error to output 16-bit data via the input/output bus 120 to the data pins 111.

Since the DRAM chip 100 is a DDR SDRAM, the main amp output for two words is originally outputted so as to be switched at the time of outputting, thereby enabling a wide-band operation. In one reading/writing operation, a plurality of words (typically, 2 to 8 words/command) are always processed. They are omitted in this description.

Based on the above, parallel testing of the DRAM chip 100 will be described. First, a parallel test when not employing an ECC will be described. Basically, the parallel test is a technique which involves connecting a number of DRAM chips 100 to a memory tester to conduct the testing in parallel, thereby reducing the test cost. The number of test pins 130 of the memory tester is limited. Depending on how many test pins 130 are used for one chip, the processing ability for one memory tester is determined. A reduction in the number of test pins per chip is important for reducing the test cost. Since the command and address given to each chip is shared, the test pins connected to the command and address pins can be shared among a number of chips. In particular, test pins connected to the data pins for receiving test results must be provided for each chip. A reduction in the number of the test pins connected to the data pins provides a high test cost reduction effect.

As shown in FIG. 1, the DRAM chip 100 is a memory having a 16-I/O 4-mat structure. In a parallel test, typically, 16 bits×4=64 bits are tested in parallel. The number of test pins connected to the 16 data pins of each chip can be reduced to four. In a simple calculation, the number of chips connected to the memory tester is four times. The four mats are tested in parallel to shorten one test time to ¼. In a combination of the two effects, the processing ability of the memory tester is 16 times. Thus, it is formed that the test cost is reduced very significantly.

The parallel test method, as an example of this embodiment, is performed according to the following operations 1) to 3).

1) A command, which is not allowed under normal standards, is used to move to a parallel test mode. That is, the command of the parallel test mode is determined by a bit pattern which is not used in the existing SDRAM. The movement to the parallel test is decoded by the command decoder 104, and a flag indicating the parallel test is written into the register 105. Other circuits are operated in the parallel test mode with reference to the flag of the register 105.

2) Data writing is performed. Here, only 4-bit data is specified. As understood from FIG. 1, only the four data pins 111_0, 111_4, 111_8 and 111_12 are connected to the test pins 130 of the memory tester. The other data pins are released. For convenience in the check performed thereafter, the data on the data pins 110_0, 110_4, 110_8 and 110_12 is the same.

The parallel test selector 107 recognizes that the operation relates to the parallel test mode and allocates the data inputted from the data pin 110_0 to bits 0, 1, 2 and 3. Similarly, the data inputted from the data pin 110_4 is allocated to bits 4, 5, 6 and 7, the data inputted from the data pin 110_8 is allocated to bits 8, 9, 10 and 11, and the data inputted from the data pin 110_12 is allocated to bits 12, 13, 14 and 15. As a result, the same data is written into all bits.

In the command and address pin 112, the command and address are operated as being normal, except for the memory mat specification. In the normal operation, only the specified memory mat is activated to perform writing/reading. In writing in the parallel test, the four mats are activated in parallel to write the same data into the memory cells in the same row and column of the four memory mats. In a normal operation, in the memory mat select signals 123_0 to 123_3, only one of the four signals is transited to Hi (high level), while all are transited to Hi in the parallel test to activate the four memory mats 101_0 to 101_3. In a parallel test, the memory mat specification is invalid, and the test pins 130 of the memory tester may be released without being connected.

3) Data reading is performed. In the same manner as data writing, the four mats are read in parallel. The same data has been written into all bits in the mats. When the memory cells are not abnormal, the same data should be read out. The parallel test decision circuits 109 decide whether all bits are in coincidence or not. When all bits are in coincidence, acceptance is indicated. When even 1 bit is non-coincident, rejection is indicated. The decision result selectors 110_0 to 110_3 output the decision results to different bits, respectively, and the other bits are unselected. Specifically, the decision result selector 110_0 outputs the decision result to bit 0, the decision result selector 110_1 outputs the decision result to bit 4, the decision result selector 110_2 outputs the decision result to bit 8, and the decision result selector 110_3 outputs the decision result to bit 12.

4) As a result, the memory tester can individually receive the decision results relating to the resting of the mats. That is, it receives the decision result of the memory mat 101_0 from the data pin 111_0, the decision result of the memory mat 101_1 from the data pin 111_4, the decision result of the memory mat 101_2 from the data pin 111_8, and the decision result of the memory mat 101_3 from the data pin 111_12. When rejection is indicated, redundancy relief is performed in the corresponding memory mat, row and column. Any memory which has not been relieved by the redundancy relief is discarded as a defective product.

The case of a DRAM according to the present invention, employing an ECC in the DRAM chip 100, will be considered here. Basically, because of a 4-mat structure with 16 I/O bits and 8 parity bits, the parallel test of (8+4)×4=96 bits may be conducted in parallel. That is, at the time of writing, the data inputted from the data pin 111_0 is allocated to data bits 0, 1, 2 and 3 and parity bits 0 and 1. Similarly, the data inputted from the data pin 111_4 is allocated to data bits 4, 5, 6 and 7 and parity bits 2 and 3, the data inputted from the data pin 111_8 is allocated to data bits 8, 9, 10 and 11 and parity bits 4 and 5, and the data inputted from the data pin 111_12 is allocated to data bits 12, 13, 14 and 15 and parity bits 6 and 7. At the time of reading, whether all of the 24 bits of the main amp output signal 127 are in coincidence or there are any non-coincident bits is determined.

In the DRAM according to the present invention, as will be described later, one of the objects of the invention is to employ an ECC to cope with a defect in the retention of memory data. In other words, the refresh interval (cycle) of the DRAM is made longer. In this case, when there is a 1-bit defect in 8+4 bits as an ECC unit, it must be decided that the product is a non-defective product. As described above, however, in the parallel test for deciding whether all bits are in coincidence or not, a 1-bit defect results in the product being rejected. To avoid this, a method for testing all bits without using the parallel test can be considered. However, this increases the test cost, which is hard to accept.

Accordingly, the present invention employs a parallel decision circuit corresponding to the ECC. Since any retention defect is relieved by the ECC, an acceptance decision is applied to a 1-bit defect in 8+4 bits. A parallel decision circuit for detecting 1-bit non-coincidence as well as all bits coincidence is required to indicate an acceptance decision.

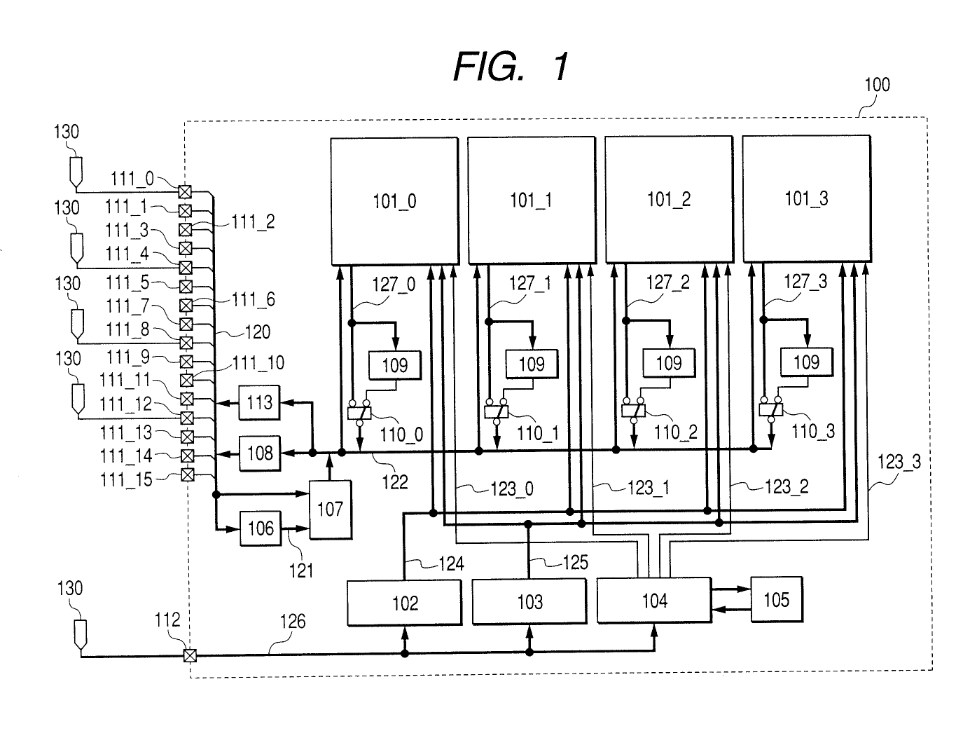

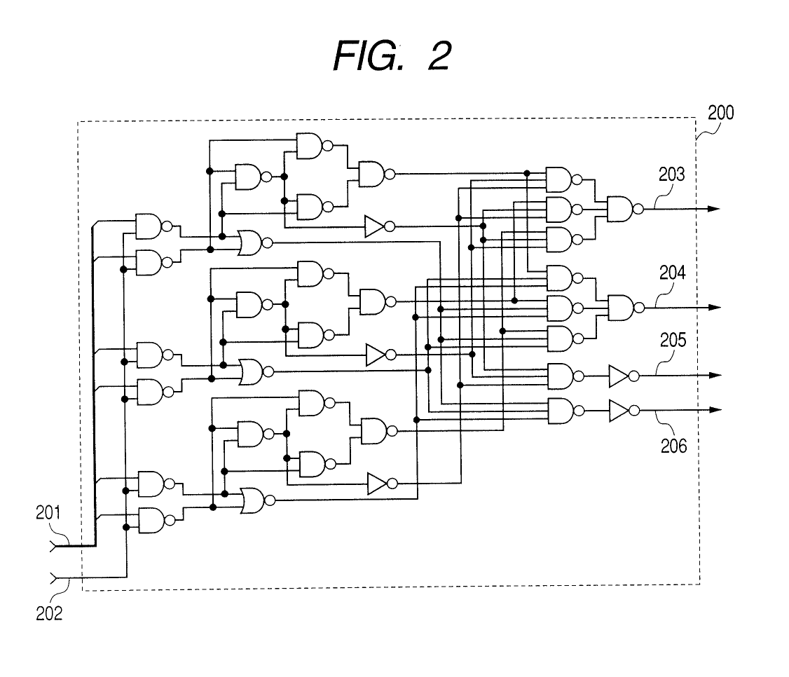

FIG. 2 is a schematic circuit diagram of an embodiment of a parallel decision circuit according to the present invention. The drawing shows a 6-bit input parallel decision circuit having a 6-bit input 201 and a decision circuit valid signal input 202; and, the decision circuit produces a 1-bit Hi (high level) decision output 203, a 1-bit Lo (low level) decision output 204; an all bits Lo (low level) output 205; and an all bits Hi (high level) output 206.

In more detail, when the decision circuit valid signal 202 is a Hi input, the 6-bit input parallel decision circuit 200 performs a decision relating to the 6-bit input 201. When the 6-bit input 201 is all bits Hi, Hi is outputted to the all bits Hi decision output 206 and the other outputs output Lo. Similarly, when the 6-bit input 201 is all bits Lo, Hi is outputted to the all bits Lo decision output 205 and the other outputs output Lo. When an arbitrary bit of the 6-bit input 201 is Hi and the remaining bits are Lo, the 1-bit Hi output 203 outputs Hi and the other outputs output Lo. Similarly, when an arbitrary bit of the 6-bit input 201 is Lo and the remaining bits are Hi, the 1-bit Lo output 204 outputs Hi and the other outputs output Lo. When the decision circuit valid signal 202 is a Lo input, the all bits Lo output 203 outputs Hi and the other outputs output Lo. In any other input pattern, all outputs output Lo.

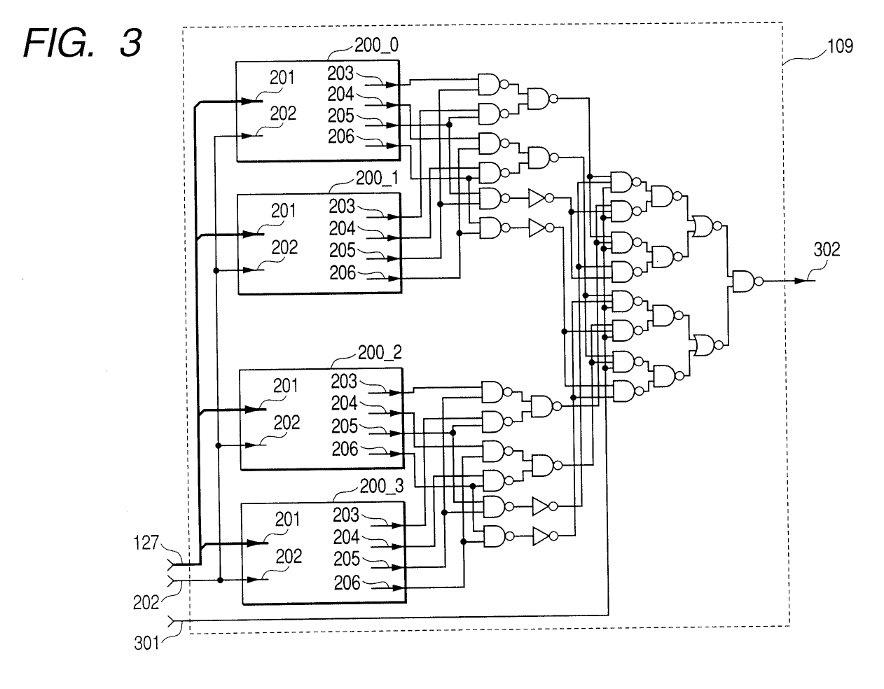

The 6-bit input parallel decision circuit 200 is used as a compound of the parallel test decision circuit 109 of FIG. 1. FIG. 3 shows the details of the parallel test decision circuit 109. The numeral 301 denotes an ECC relief valid signal; and the numeral 302 denotes a parallel test decision result signal. The decision circuit valid signal 202 and the ECC relief valid signal 301 in FIG. 3 input a value that has been written into the register 105, which is omitted in FIG. 1 for simplification.

When the decision circuit valid signal 202 is a Hi input, the parallel test decision circuit 109 determines coincidence/non-coincidence of the main amp output signal 127. When the decision circuit valid signal 202 is a Lo input, Hi is outputted regardless of the value of the main amp output signal 127. When the decision circuit valid signal 202 is Hi and the ECC relief valid signal 301 is Lo and all bits of the main amp output signal 127 are in coincidence, the parallel test decision result signal 302 outputs Hi. When even 1 bit of the main amp output signal 127 is non-coincident, the parallel test decision result signal 302 outputs Lo.

When the decision circuit valid signal 202 is Hi and the ECC relief valid signal 301 is Hi, a decision assuming relief in the ECC is produced. The main amp output signal 127 as a 24-bit signal, consisting of data of 16 bits and parity of 8 bits, is divided into 12-bit signals consisting of data of 8 bits and parity of 4 bits for each ECC relief unit. A first ECC relief unit has data bits 0 to 7 and parity bits 0 to 3, and a second ECC relief unit has data bits 8 to 15 and parity bits 4 to 7. Needless to say, the parallel test decision circuit 109 outputs Hi when all bits are in coincidence. When there is 1-bit non-coincidence in all bits, there is 2-bit non-coincidence in all bits and the respective non-coincident bits exist in another ECC relief unit, Hi is outputted. In any other bit pattern, Lo is outputted.

The signal of the first ECC relief unit is inputted to the 6-bit input parallel decision circuits 200_0 and 200_1, and the signal of the second ECC relief unit is inputted to the 6-bit input parallel decision circuits 200_2 and 200_3. A decision is performed for each of the 6 bits. The decision results are summed in a combination circuit for outputting the parallel test decision result signal 302 as a final decision result. A pseudo independent parallel test will be described. In the above-described parallel test, since the same data is written into all bits in all mats, no defect depending on the data pattern can be detected. In the parallel test, data is read and written by the four test pins 130 of the memory tester. This is used to test a bit pattern to some extent in the parallel test, which is a pseudo independent parallel test.

The pattern in which the four test pins 130 of the memory tester are allocated to the bits is the same as the parallel test, except that at the time of writing, writing is performed to only one mat and an arbitrary data pattern is inputted to each of the test pins 130 of the memory tester. At the time of reading, the coincidence/non-coincidence of the bits allocated to the test pins 130 of the memory tester is determined by the pseudo independent decision circuit 113. As compared with the case in which the test pins 130 are connected to all of the data pins 111, needless to say, the data pattern is limited. Any defect which has not been found in the parallel test can be selected.

When an ECC relief decision is incorporated into the pseudo independent parallel test, a problem which has not been imposed in the parallel test, arises. For example, the bits allocated to the data pin 111_0 are data bits 0 to 3 and parity bits 0 and 1, and the bits allocated to the data pin 111_4 are data bits 4 to 7 and parity bits 2 and 3. Since different data may be written into the bits allocated to the data pin 111_0 and the bits allocated to the data pin 111_4, coincidence/non-coincidence for the bits must be decided individually. When 1-bit non-coincidence is decided as being accepted, a 2-bit defect may be determined as being accepted in the same ECC relief unit. A mechanism for avoiding this is necessary for the pseudo independent decision circuit 113.

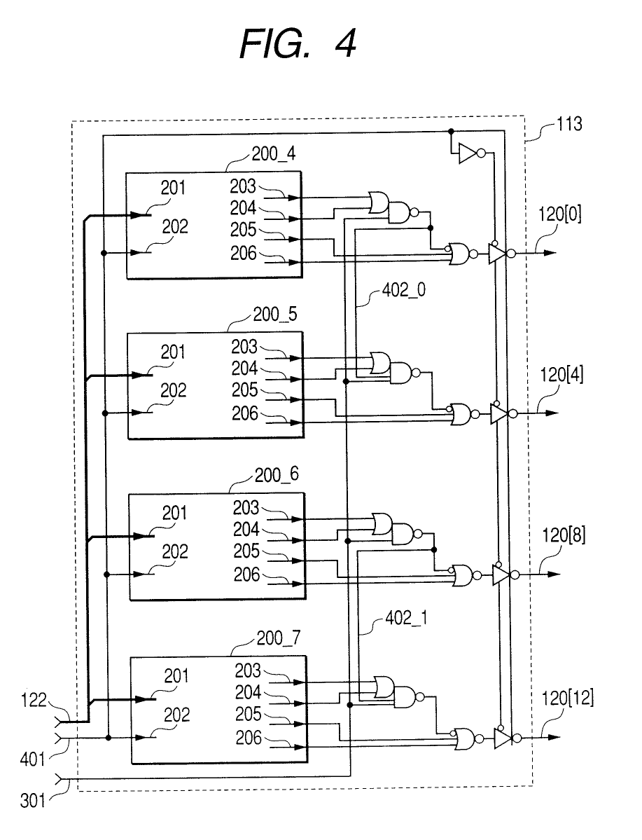

FIG. 4 shows a detailed diagram of the pseudo independent decision circuit 113. The numeral 401 denotes a pseudo independent decision circuit valid signal; and the numerals 402_0 and 402_1, denotes a 1-bit defect decision signal. Data bits 0 to 3 and parity bits 0 and 1 of the global I/O bus 122 are inputted to the 6-bit input parallel decision circuit 200_4. Similarly, data bits 4 to 7 and parity bits 2 and 3 are inputted to the 6-bit input parallel decision circuit 200_5; data bits 8 to 11 and parity bits 4 and 5 are inputted to the 6-bit input parallel decision circuit 200_6; and data bits 12 to 15 and parity bits 6 and 7 are inputted to the 6-bit input parallel decision circuit 200_7.

When the pseudo independent decision circuit valid signal 401 is Lo, a decision of coincidence/non-coincidence is not performed, and all outputs are HiZ (high impedance). When the pseudo independent decision circuit valid signal 401 is Hi and the ECC relief valid signal 301 is Lo, the logical addition of the all bits Hi decision output 206 and the all bits Lo decision output 205, which are produced in the 6-bit input parallel decision circuits 200_4 to 200_7, is outputted. That is, when all bits are in coincidence in the 6-bit input parallel decision circuits 200_4 to 200_7, the respective outputs indicate an acceptance decision.

Then the pseudo independent decision circuit valid signal 401 is Hi and the ECC relief valid signal 301 is Hi, the operation is slightly more complicated. The 6-bit input parallel decision circuit 200_4 and the 6-bit input parallel decision circuit 200_6 produce the logical addition of the 1-bit Hi decision output 203, the 1-bit Lo decision output 204, the all bits Lo output 205 and the all bits Hi output 206; and the result is outputted. All bits coincidence or 1-bit non-coincidence in 6 bits results in an acceptance decision.

The output results of the 6-bit input parallel decision circuit 200_5 and the 6-bit input parallel decision circuit 200_7 are changed by the operation of the 6-bit input parallel decision circuit 200_4 and the 6-bit input parallel decision circuit 200_6. The 6-bit input parallel decision circuit 200_5 receives the 1-bit defect decision signal 402_0 from the 6-bit input parallel decision circuit 200_4.

When the 6-bit input parallel decision circuit 200_4 detects a 1-bit defect, the line 120[0] outputs an acceptance decision and, at the same time, the 1-bit defect decision signal 402_0 is Lo. In this case, the 1-bit defect decision of the 6-bit input parallel decision circuit 200_5 is indicated as being rejected. This can hold the limit of the 1-bit defect in the ECC relief units. The operations of the 6-bit input parallel decision circuits 200_6 and 200_7 are performed in the same manner to hold the limit of the 1-bit defect in the ECC relief units.

As the ECC relief unit of the ECC is increased, the number of parity bits can be reduced. For example, when structuring an ECC capable of correcting a 1-bit error to 128-bit data, 8 parity bits may be added. In a DRAM chip employing such an ECC, one row address and column address specification is performed to output at least 128+8 bits as a main amp output from the memory mat. In the parallel test, the four mats need not be activated in parallel to complete the parallel test in one memory mat.

However, a problem arises when outputting the result of the parallel test to the outside. As in the above embodiment, the redundancy relief is performed for each data of 16 bits+parity, and the test pins of the memory tester are connected to four data pins. In this case, only the test result for data of 64 bits can be outputted for one access. Thus, 128+8 bits are tested in two steps.

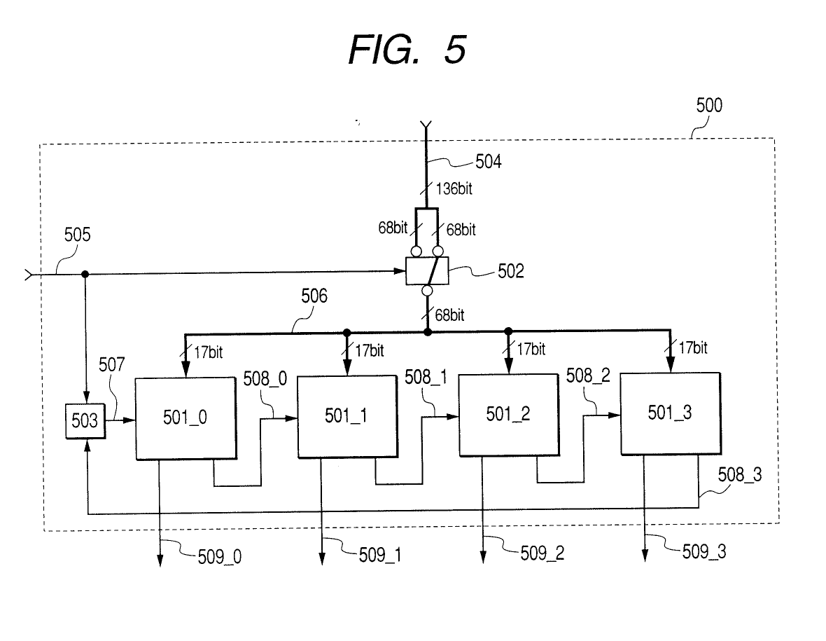

FIG. 5 shows a parallel test decision circuit 500 employing an ECC with 128+8 bits in which there are 17-bit input parallel decision circuits 501_0 to 501_3; a switching device 502; a register 503; a main amp output line 504; an address switch signal line 505; a parallel test input signal line 506; a register output line 507; lines 508_0 to 508_3 which carry a 1-bit defect flag; test decision signal line 509.

A parallel test conduction method when employing the ECC with 128+8 bits will be described in connection with the following operations 1) to 5).

1) Parallel writing is not much different from the operation described above except that writing is performed to one mat in a 128+8 bit unit. To shorten the test time, writing is performed to four mats in parallel.

2) At the time of reading, when a row address and a column address are specified, the main amp output 504 with 128+8 bits can be obtained. The least significant bit of the column address is inputted as the address switch signal 505 to the parallel test decision circuit 500. Here, 0 is assumed to be specified to the least significant bit of the column address for a first time. When the address switch signal 505 is 0, the register 503 is reset to output logic 0.

3) Since the address switch signal 505 is logic 0, the low-order 68 bits of the main amp output 504 are selected by the switching device 502 so as to be inputted to the 17-bit input parallel decision circuit 501 for each 17 bits.

4) When all 17 bits are in coincidence, the 17-bit input parallel decision circuit 501_0 outputs an acceptance decision to the test decision signal line 509_0 regardless of the value of the register output 507. When there is a 1-bit non-coincidence, the value of the register output 507 is referred to. When the value of the register output 507 is logic 0, an acceptance decision is outputted to the test decision signal line 509_0. When it is logic 1, a rejection decision is outputted thereto. When a defect with 2 bits or more occurs, a rejection decision is outputted to the test decision signal line 509_0 regardless of the value of the register output 507. Logic 1 is outputted to the 1-bit defect flag output line 508_0 when the register output 507 is logic 1. In the case of a 1-bit defect, logic 1 is also outputted thereto. In a case other than that, logic 0 is outputted thereto.

5) The 17-bit input parallel decision circuits 501_1 to 501_3 determine acceptance or rejection while referring to the 1-bit defect flag outputs 508_0 to 508_2 in the previous stage. The 1-bit defect output of the 17-bit input parallel decision circuit 501_3 is stored in the register output 507 and is outputted when the address switch signal 505 is switched to logic 1.

6) The least significant bit of the column address is switched to 1. At this time, the main amp is not operated. When the address switch signal 505 is 1, the high-order 68 bits of the main amp output 504 are selected by the switching device 502 so as to be inputted to the 17-bit input parallel decision circuit 501 for each 17 bits.

7) The acceptance/rejection decision is performed as in the case in which the address switch signal 505 is logic 0. Only in the decision of the 17-bit input parallel decision circuit 501_0, the value of the 1-bit defect flag 508_3, when the address switch signal 505 is logic 0, is stored in the register 503. The acceptance/rejection decision is performed according to this value.

8) As described above, the 1-bit defect flags 508 are transmitted sequentially to the next stage. The condition that only a 1-bit defect is allowed in 128+8 bits is held. In such a method, the possibility that the 1-bit defect may be allowed or redundancy-relieved is unbalanced. The possibility that a plurality of 1-bit defects may occur in 128+8 bits is low, so that this is not substantially a problem.

In summary, when an ECC relief unit n is smaller than a redundancy relief unit m and a parallel test decision unit p (n<m and n<p), a decision is performed under the condition that a 1-bit defect is allowed for each ECC unit. According to this, an acceptance/rejection decision of the redundancy relief unit is obtained. On the contrary, when the ECC relief unit n is larger than the redundancy relief unit m or the parallel test decision unit p (n>m or n>p), the conditions of all bits acceptance, a 1-bit defect or a defect with 2 bits or more is determined in each redundancy relief unit or parallel test decision unit, and when a 1-bit defect is detected in another location, the decision result is outputted so that the number of defects in the ECC relief unit will not exceed 1 bit. When the ECC relief unit is operating across a plurality of addresses, a 1-bit defect flag may be stored in the register for reference in the acceptance-rejection decision in another address.

In the above-described embodiments, the ECC corrects a 1-bit defect. Depending on the ECC structuring method, a defect with 2 bits or more can be corrected. An ECC capable of correcting an m-bit defect is employed to produce a decision in such a manner that a product with an n-bit defect is designated as a non-defective product in the ECC relief unit (m≧n). Also in this case, the basic idea is the same as that described above, and the decision of 1-bit non-coincidence as being accepted may be changed to the decision of n-bit non-coincidence as being accepted. When the ECC relief unit n is larger than the redundancy relief unit m or the parallel test decision unit p, a 1-bit defect flag may be extended to a plurality of bits for multiplication by the number of defective bits, thereby changing the decision result so as not to exceed n.

In this embodiment, response to the ECC is processed in the DRAM chip, and when viewed from outside, this case is not different from the case where there is no ECC. The output of the DRAM is tri-state. Generally, the memory tester can function with a tri-state device. The all bits acceptance may be a Hi output, the 1-bit defect may be a HiZ output (high impedance output), and the defect with 2 bits or more may be a Lo output. How the redundancy relief is performed may be left to the program of the outside.

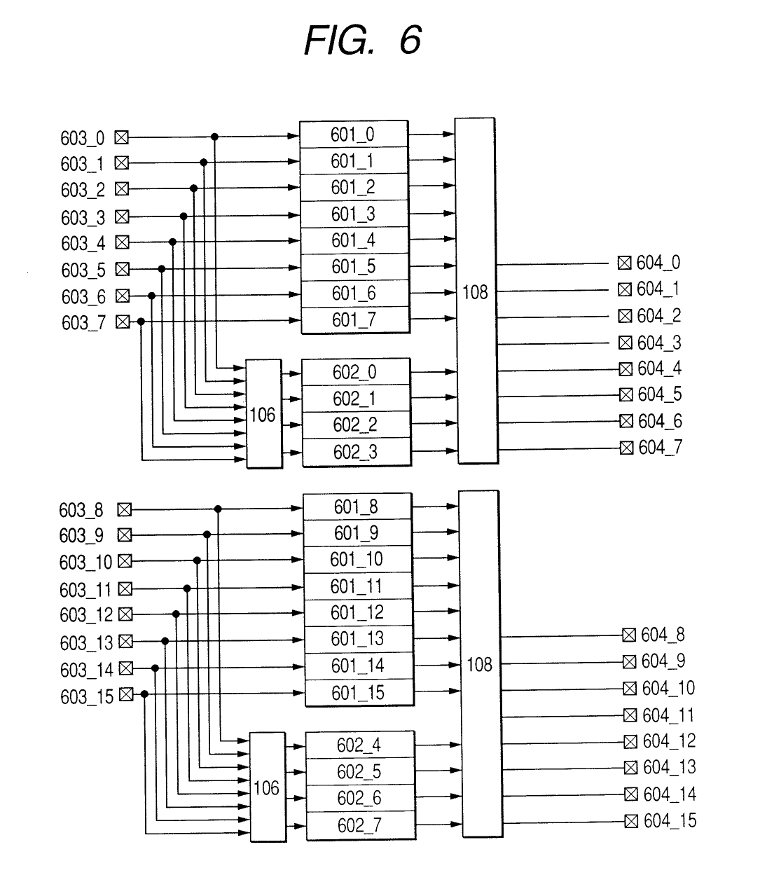

The above description is mainly directed to a parallel test. The parallel test selects defective chips before shipping. However, when checking for design mistakes, a more detailed test must be conducted. When employing an ECC, any inside defect is hidden so as to inhibit the checking of design mistakes. It is convenient that the DRAM employing the ECC can process data bits and parity bits other than via the ECC. To simplify the later discussion, a basic data flow will be described with reference to FIG. 6.

FIG. 6 shows an example of the data flow. It should be noted that it is not always in coincidence with an actual signal line connection. Input data 603_0 to 603_15 are inputted so as to be stored in memory cells 601_0 to 601_15. Based on the input data 603_0 to 603_15, the parity generation circuit generates parity bits and stores them in memory cells 602_0 to 602_7.

In data reading, error correction is performed in the ECC decoders 108, from the data and parity bits stored in the memory cells 601_0 to 601_15 and 602_0 to 602_7, when outputting output data 604_0 to 604_15.

It should be noted that the parity bits stored in the memory cells 602_0 to 602_7 are internally generated by the parity generation circuit 106, which is not controllable. Error correction of the memory cells 601_0 to 601_15 and 602_0 to 602_7 is performed in the ECC decoders 108, which is not observable. To check the internal circuits is thus very difficult. To avoid this, all memory cells are allowed to be controllable and observable. To allow the memory cells for data bits 601_0 to 601_15 to be observable, the ECC decoders 108 do not perform error correction, which is a technique typically used.

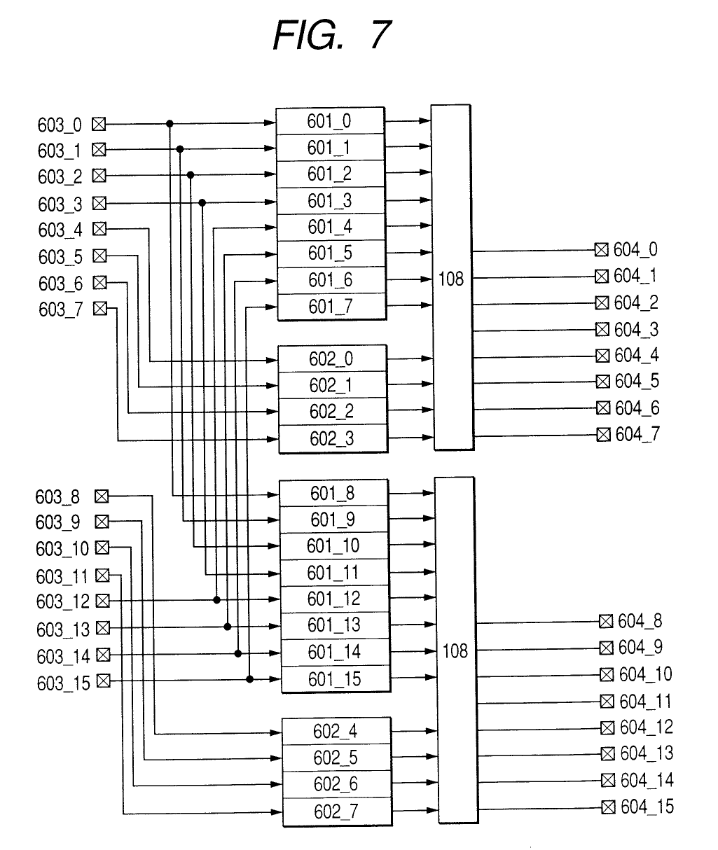

To allow the memory cells for parity bits 602_0 to 602_7 to be controllable, a signal line connection as shown in FIG. 7 is provided. The inputs 603_4 to 603_11 are allocated to the memory cells for parity bits 602_0 to 602_7. This can be performed by a general memory device employing the ECC. The connection is further contrived. The memory cells for parity bits 602_0 to 602_7 are connected to the inputs 603_4 to 603_11 so that the memory cells for data bits 601_4 to 601_11 are brought into the state of “Don't care”. Generally, the inputs 603_4 to 603_11 remain connected or no data is written into the memory cells for data bits 601_0 to 601_15.

In accordance with the present invention, the inputs 603_12 to 603_15 are allocated to the memory cells for data bits 601_4 to 601_7. The inputs 603_0 to 603_3 are allocated to the memory cells for data bits 601_8 to 601_11. Thus, an arbitrary bit pattern can be allocated to the memory cells 601_0 to 601_7+602_0 to 602_3 in the ECC relief unit. The memory cells 601_8 to 601_15+602_4 to 602_7 are similar. This can arbitrarily supply an input to the ECC decoders 108, thereby making the debug operation efficient. The data connection change is performed in the parallel test selector 107 shown in FIG. 1.

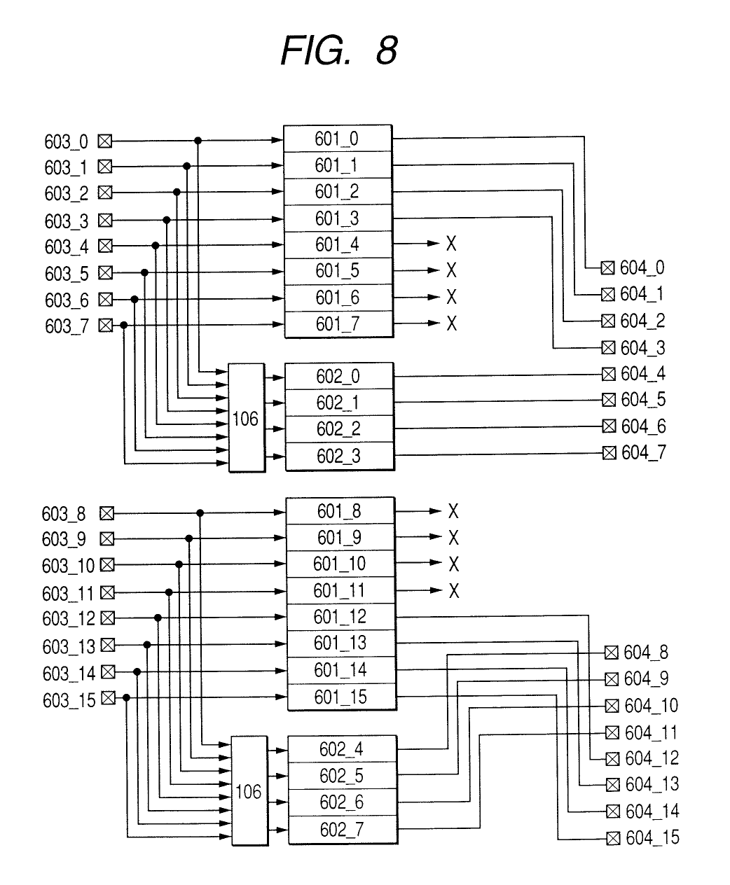

To allow the memory cells for parity bits 602_0 to 602_7 to be observable, a signal line connection as shown in FIG. 8 is provided. The memory cells for parity bits 602_0 to 602_7 are connected to the outputs 604_4 to 604_11. The memory cells for data bits 601_0 to 601_3 are connected to the outputs 604_0 to 604_3. The memory cells for data bits 601_12 to 601_15 are connected to the outputs 604_12 to 604_15.

To the memory cells for parity bits 602_0 to 602_7 to be observable, they may simply be connected to the outputs. Not only the memory cells for parity bits, but also the memory cells for data bits are connected to the outputs for the following reasons. The input portion of the connection method for allowing the memory cells for parity bits 602_0 to 602_7 to be controllable, which is shown in FIG. 7, and the output portion of the connection method for allowing the memory cells for parity bits 602_0 to 602_7 to be observable, are used in parallel. The DRAM can be regarded as a DRAM not employing a simple ECC. This means that the program of the memory tester for checking the memory cells need not be changed. The debug operation can be significantly efficient.

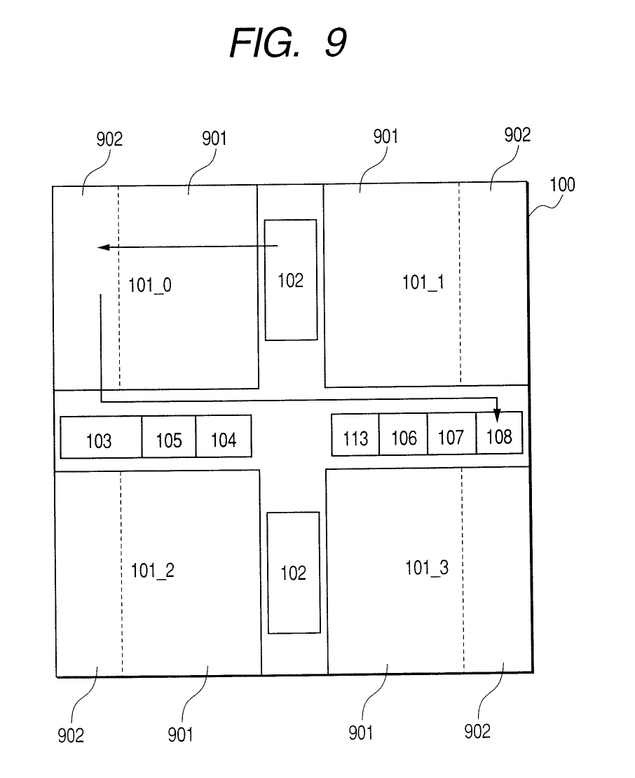

FIG. 9 shows an example of the layout of the DRAM chip 100. The memory arrays 101_0 to 101_4 are arranged in the four corners of the chip, and peripheral circuits are arranged in the middle portion, as shown in FIG. 9, which is the basic arrangement of the DRAM chip design. The arrangement is such that the data flow at the time of reading the DRAM chip 100 is as shown by the arrows in FIG. 9.

Since the DRAM chip 100 employs an ECC, a lowered speed at the time of reading becomes a problem. The memory arrays 101_0 to 101_4 are divided into data parts and parity parts to arrange parity in the positions in which the data flow is slow. In the example of FIG. 9, data is arranged in parts 901 and parity is arranged in parts 902. The algorithm of the ECC is omitted. The critical path in the ECC is the data flow. The access speed is not lowered when parity is slightly late. This arrangement increases the entire access speed. In this example, the memory arrays 101_0 to 101_4 are divided into left and right sides. Regardless of the method of division, data speed-dependent is apparent.

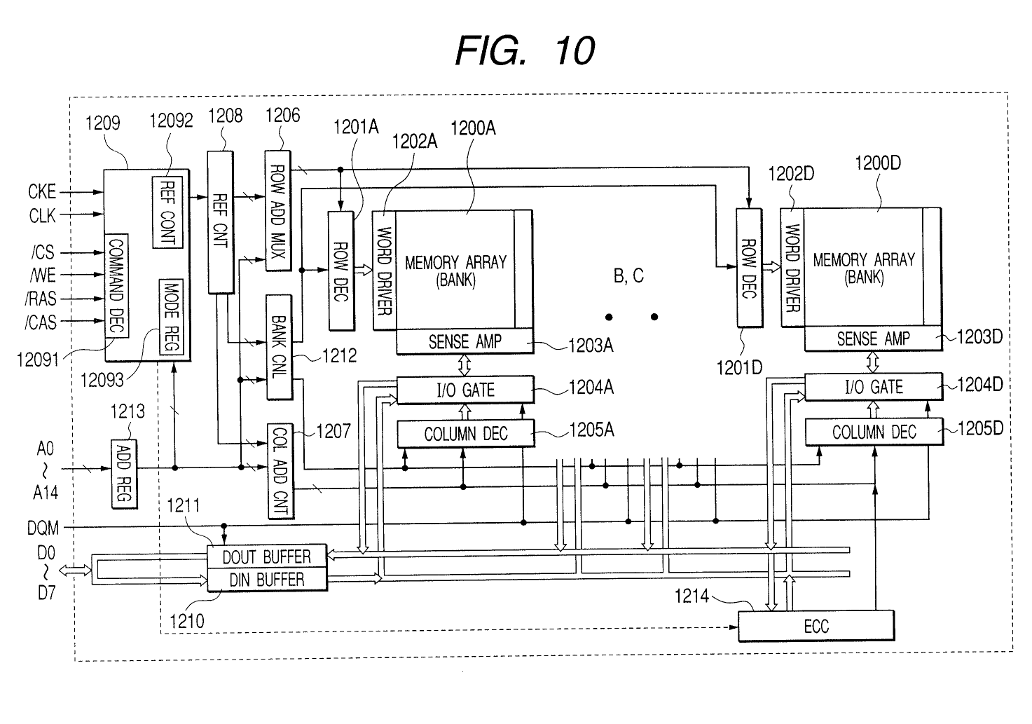

FIG. 10 shows an overall block diagram of an embodiment of a dynamic RAM (hereinafter, simply called a DRAM) according to the present invention. The DRAM of this embodiment is intended to operate as an SDRAM (Synchronous Dynamic Random Access Memory). Though the invention is not particularly so limited, the SDRAM of this embodiment is provided with four memory arrays (MEMORY ARRAYs) 1200A to 1200D corresponding to four memory banks (BANKs). In the drawing, the two memory arrays 1200A and 1200D are representatively exemplified. The memory arrays 1200A to 1200D corresponding to the four memory banks 0 to 3 each have dynamic memory cells arranged in a matrix arrangement. The select terminals of the memory cells that are arranged vertically in the memory array, as seen in the drawing, are connected to word lines, not shown, and the data input/output terminals of the memory cells arranged horizontally therein are connected to complementary data lines, not shown, for each row.

One word line, not shown, of the memory array 1200A is driven at the select level according to the decode result of the row address signal of the row decoder (ROW DEC) 1201A. The row decoder 12001A includes a word driver (WORD DRIVER) for the select level of one word line according to the decode result. The complementary data line, not shown, of the memory array 1200A is connected to an input/output line (IO line) by a sense amp (SENSE AMP) 1203A, an IO gate circuit (I/O GATE) 1204A serving as a column select circuit, and a column decoder (COLUMN DEC) 1205A. The IO gate includes a main amp and a write amp.

The sense amp 1202A is an amplification circuit for detecting and amplifying a small potential difference which appears on the respective complementary data lines by data read from the memory cells. The IO gate circuit 1204A includes switch MOSFETs for selecting the respective complementary data lines to be made conductive to the complementary I/O lines. The column switch MOSFET is selectively operated by the decode result of the column address signal of the column decoder 1205A. Similarly, the memory arrays 1200B and 1200C, not shown, are provided with row decoders 1201B and 1201C, sense amps 1203B and 1203C, IO gate circuits 1203B and 1203C and column decoders 1205B and 1205C, respectively. The I/O line is shared among the memory banks and is connected to the output terminal of a data input circuit (DIN BUFFER) 1210 and the input terminal of a data output circuit (DOUT BUFFER) 1211. Although the invention is not particularly so limited, terminals D0 to D7 are data input/output terminals for inputting or outputting 8-bit data D0 to D7.

Address signals A0 to A14 supplied from the address input terminals are first held by an address register (ADD REG) 1213. The row address signals for selecting the memory cell, of those address signals chronologically inputted, are supplied via a row address multiplexer (ROW ADD MUX) 1206 to the row decoders 1201A to 1201D of the memory banks. The bits A13 and A14 as the address signals for selecting the memory bank are allocated and are supplied to a bank control (BANK CNL) circuit 1212 to form select signals of the four memory banks. The column address signals are held by a column address counter (COLUMN ADD CNT) 1207. A refresh counter (REF CNT) 1208 generates a row address at Automatic Refresh and a row address and a column address at Self Refresh.

With a 256-Mbit memory capacity, up to the column address signals A10 is valid in an 8-bit structure. The column address signals chronologically inputted are supplied as preset data to the column address counter 1208. The column address signals as the preset data in a burst mode, which are specified by the later-described command or values obtained by sequentially incrementing the column address signals, are outputted to the column decoders 1205A to 1205D of the memory banks.

A control logic (CONTROL LOGIC) 1209 has a command decoder (COMMAND DEC) 12091, a refresh control (REF CONTROL) 12092 and a mode register (MODE REG) 12093. The mode register 12093 holds various kinds of operation mode information. Only one corresponding to the bank specified by the bank control circuit 1212 of the row decoder 1201A to 1201D operates to perform a word line select operation.

Although the invention is not particularly so limited, the control circuit 1209 to which external control signals, such as clock signal CLK, clock enable signal CKE, chip select signal /CS (The symbol/means that a signal given it is a row enable signal.), column address strobe signal/CAS, row address strobe signal /RAS and write enable signal /WE, DQM and the address signals via the mode register 12093 are supplied, forms an internal timing signal for controlling the operation mode of the SDRAM and the operation of the circuit blocks based on a change in level and timing of the signals, and it has an input buffer corresponding to the signals.

Other external input signals are significant in synchronization with the rising edge of the internal clock signal. The chip select signal /CS instructs the start of the command input cycle by its low level. When the chip select signal /CS is at high level (chip unselected state), other inputs are invalid. The later-described internal operation, such as the selected state of the memory bank or burst operation, is not affected by the change to the chip unselected state. The respective signals /RAS, /CAS and /WE have a function different from that of the corresponding signal in a typical DRAM and are significant signals for the later-described command cycle definition.

The clock enable signal CKE is a signal instructing the validity of the next clock signal. When the signal CKE is at high level, the rising edge of the next clock signal CLK is valid. When it is at low level, it is invalid. In the read mode, when provided with an external control signal/OE for controlling output enable to a data output circuit 1211, the signal/OE is supplied to the control circuit 1209. When the signal is at high level, the data output circuit 1211 is brought into a high output impedance state.

The row address signal is defined by the levels of A0 to A12 in the row address strobe and bank active command cycle in synchronization with the rising edge of the clock signal CLK (internal clock signal).

The address signals A13 and A14 are regarded as bank select signals in the row address strobe and bank active command cycle. That is, a combination of the A13 and A14 bits selects one of the four memory banks 0 to 3. Although the invention is not particularly so limited, the select control of the memory banks can be performed by the processing of activation of only the row decoder on the selected memory bank side, non-selection of all column switch circuits on the unselected memory bank side, and connection of the data input circuit 1210 and the data output circuit only on the selected memory bank side.

In the SDRAM, when the burst operation is performed in one memory bank, another memory bank is specified to supply a row address strobe and bank active command, the row address operation in the other memory bank is enabled without affecting the one memory bank during execution. Unless a collision among the data D0 to D7 occurs in an 8-bit data input/output terminal, a precharge command and a row address strobe and bank active command to a memory bank that is different from the memory bank processed by the command during execution are issued during the execution of the command whose processing has not been ended, thereby starting the internal operation.

An internal power generation circuit, not shown, is provided to generate various internal voltages, such as an internal rising voltage VPP corresponding to the select level of the word line, upon reception of an operation voltage, such as VCC and VSS supplied from the power terminal. an internal dropping voltage VDL corresponding to the operation voltage of the sense amp, an internal dropping voltage VPERI corresponding to the operation voltage of the peripheral circuit, a plate voltage of the memory cell, not shown, a precharge voltage such as VDL/2, and a substrate back bias voltage VBB.

In the DRAM of this embodiment, an ECC circuit 1214 as described above is provided in the DRAM chip. The ECC circuit 1214 is shared among the four memory banks 1200A to 1200D. A check bit is generated to write data inputted from the input circuit 1210 to be written into the selected memory bank with the write data. At the time of the reading operation, the data and check bit are read from the selected memory bank to output, via the output circuit 1211, data in which error detection correction has been performed.

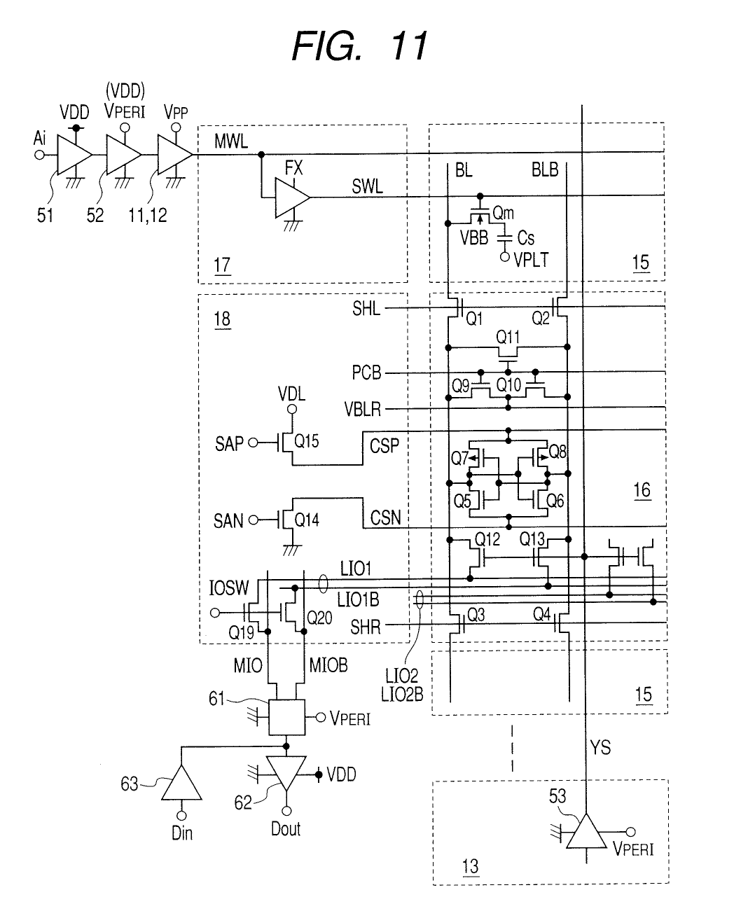

FIG. 11 shows a circuit diagram of an embodiment of a DRAM according to the present invention. In the drawing, with the sense amp part as the middle, a circuit diagram simplifying the address input to the data output is illustrated. In this embodiment, a pair of complementary bit lines are returned at the sense amp as the middle to be extended in parallel, which is a so-called 2-cross point method. In the drawing, there are provided hierarchical structures so that the word line consists of a main word line MWL and a sub word line SWL and the input/output line consists of a local input/output line LIO and a main input/output line MIO. A circuit provided on a sense amp 16 and a cross area 18 so as to be vertically interposed between two sub arrays 15 is illustrated. Others are shown as a block diagram.

One dynamic memory cell provided between the sub word line SWL provided in the one memory mat 15 and one bit line BL of complementary bit lines BL and BLB is representatively illustrated. The dynamic memory cell has an address select MOSFET Qm and a memory capacitor Cs. The gate of the address select MOSFET Qm is connected to the sub word line SWL, the drain of the MOSFET Qm is connected to the bit line BL, and the source thereof is connected to the memory capacitor Cs. The other electrode of the memory capacitor Cs is shared and is given the plate voltage VPLT. The negative back bias voltage VBB is applied to the substrate (channel) of the MOSFET Qm. Although the invention is not particularly so limited, the back bias voltage VBB is set to a voltage of −1 V. The select level of the sub word line SWL is the high voltage VPP, which is higher by the threshold voltage of the address select MOSFET Qm than the high level of the bit line.

When the sense amp is operated by the internal dropping voltage VDL, the high level amplified by the sense amp to be given to the bit line is at the internal voltage VDL level. The high voltage VPP corresponding to the select level of the word line is VDL+Vth+α. A pair of the complementary bit lines BL and BLB of the sub array provided on the left side of the sense amp are arranged in parallel, as shown in the drawing. The complementary bit lines BL and BLB are connected to the input/output nodes of the unit circuit of the sense amp by shared switch MOSFETs Q1 and Q2.

The unit circuit of the sense amp is constructed by a CMOS latch circuit having N-channel amplification MOSFETs Q5 and Q6 and P-channel amplification MOSFETs Q7 and Q8, which is in a latch form produced by cross-connecting the gates and the drains. The sources of the N-channel MOSFETs Q5 and Q6 are connected to common source line CSN. The sources of the P-channel MOSFETs Q7 and Q8 are connected to common source line CSP. The common source lines CSN and CSP are connected to power switches MOSFETs, respectively.

Although the invention is not particularly so limited, the common source line CSN connected to the sources of the N-channel amplification MOSFETs Q5 and Q6 is given an operation voltage corresponding to the ground potential by an N-channel power switch MOSFET Q14 provided in the cross area 18. The common source line CSP connected to the sources of the P-channel amplification MOSFETs Q7 and Q8 is provided with an N-channel power MOSFET Q15 for supplying the internal voltage VDL. The power switch MOSFETs may be provided so as to be distributed in the unit circuits. Activating signals for the sense amps SAN and SAP, which are supplied to the gates of the N-channel power MOSFETs Q14 and Q15, are signals in the same phase that are at high level at the time of activation of the sense amp. The high level of the signal SAP is a signal at the rising voltage VPP level. The rising voltage VPP is about 3.6V when VDL is 1.8V. The N-channel MOSFET Q15 is sufficiently brought into the on state to allow the common source line CSP to be at the internal voltage VDL level.

The input/output nodes of the unit circuit of the sense amp are provided with a precharge (equalize) circuit having an equalize MOSFET Q11 for short-circuiting the complementary bit lines, and switch MOSFETs Q9 and Q10 for supplying a half precharge voltage VBLR to the complementary bit lines. A precharge signal PCB is sharably supplied to the gates of the MOSFETs Q9 to Q11. A driver circuit for forming the precharge signal PCB is provided with an inverter circuit, not shown, in the cross area to make the rising or falling faster. Prior to the word line select timing at the start of the memory access, the MOSFETs Q9 to Q11 constructing the precharge circuit are switched at high speed via the inverter circuits that are distributed in the cross areas.

An 10 switch circuit IOSW (switch MOSFETs Q19 and Q20 for connecting the local input/output line LIO and the main input/output line MIO) is placed on the cross area 18. As described above, there are also provided a half precharge circuit of the common source lines CSP and CSN of the sense amp, a half precharge circuit of the local input/output line LIO, a VDL precharge circuit of the main input/output line, and a distribution driver circuit of shared select signal lines SHR and SHL.

The unit circuit of the sense amp is connected via shared switch MOSFETs Q3 and Q4 to similar complementary bit lines BL and BLB of the sub array 15, as seen on the lower side in the drawing. For example, when the sub word line SWL of the sub array on the upper side is selected, the upper-side shared switch MOSFEs Q1 and Q2 of the sense amp are brought into the on state, and the lower-side shared switch MOSFETs Q3 and Q4 are brought into the off state. The switch MOSFETs Q12 and Q13 construct a column (Y) switch circuit. When the select signal YS is at the select level (high level), it is brought into the on state so as to connect the input/output nodes of the unit circuit of the sense amp to the local input/output lines LIO1 and LIO1B, LIO2 and LIO2B.

The input/output nodes of the sense amp are connected to the upper-side complementary bit lines BL and BLB, the small signal of the memory cell connected to the selected sub word line SWL is amplified, and it is transmits via the column switch circuits (Q12 and Q13) to the local input/output lines LIO1 and LIO1B. The local input/output lines LIO1 and LIO1B are extended along the sense amp column, that is, horizontally as seen in the drawing. The local input/output lines LIO1 and LIO1B are connected via the IO switch circuit having the N-channel MOSFETs Q19 and Q20 provided in the cross area 18 to the main input/output lines MIO and MIOB connected to the input terminals of a main amp 61.

The IO switch circuit is switch-controlled by the select signal formed by decoding an X address signal. The IO switch circuit may have a CMOS switch structure in which the N-channel MOSFETs Q19 and Q20 are connected in parallel to the P-channel MOSFETs, respectively. In the burst mode of the synchronous DRAM, the column select signal YS is switched by counter operation to sequentially switch connections of the local input/output lines LIO1 and LIO1B, and LIO2 and LIO2B to two pairs of the complementary bit lines BL and BLB of the sub arrays.

An address signal Ai is supplied to an address buffer 51. The address buffer is operated in time division to fetch an X address signal and a Y address signal. The X address signal is supplied to a predecoder 52 to form a select signal of the main word line MWL via a main row decoder 11 and a main word driver 12. The address buffer 51 receives the address signal Ai supplied from the external terminal and is operated by the source voltage VDD (or VCC) supplied from the external terminal. The predecoder is operated by the dropping voltage VPER1 dropping. The main word driver 12 is operated by the rising voltage VPP. As the main word driver 12, a logic circuit with a level conversion function for receiving the predecode signal is used. A column decoder (driver) 53 includes a driving circuit in which an operation voltage is formed by a MOSFET Q23 constructing the VCLP generation circuit, and it receives the Y address signal supplied by the time division operation of the address buffer 51 to form the select signal YS.

The main amp 61 is operated by the dropping voltage VPERI and is outputted from an external terminal Dout via an output buffer 62 that is operated by the source voltage VDD supplied from the external terminal. The write signal inputted from an external terminal Din is fetched via an input buffer 63 to supply the write signal via the write amp (write driver) that is included in the main amp 61 to the main input/output lines MIO and MIOB. The input part of the output buffer 62 is provided with a level conversion circuit and a logic part for outputting a signal in synchronization with a timing signal corresponding to the clock signal.

As the main memory device of a computer system, a dynamic random access memory (DRAM) using a semiconductor is generally used. As compared with other semiconductor memory devices, the DRAM has a high degree of integration and can read and write information relatively fast. One problem of the DRAM, however, is that the memory holding time is very short (typically, about tens of ms to 1 s) so that the memory updating operation called refresh must be frequently performed. Since reading and writing of information cannot be performed during the refresh operation, the refresh operation limits the speed for reading and writing information in the DRAM.

Basically, the information position in the DRAM is specified by the row address and the column address. When the degree of integration of the DRAM rises by one generation, the row address is doubled, the column address is doubled and the capacity is four times. The refresh of the memory is performed by row address specification. For each generation rise, the number of times of refresh is doubled. In the prior art, for each successive generation, the refresh interval tREF is doubled to hold the time for refresh per unit time constant. The refresh time per unit time is called a busy factor (γ) and is represented by Equation 1.

$$γ = \frac{t R C min \times n}{t R E F} \qquad [ Equation 1 ]$$

The increase in the degree of integration of the DRAM means that the area of the memory cell used for holding data is reduced. When the memory cell area is reduced, the capacity of the capacitor is reduced. Basically, the memory holding time is shortened. Attempts have been made to increase the capacity of the capacitor by making the memory cells three-dimensional (stacked capacitor or trench capacitor), thinning the insulating film and using a high dielectric material.

The making of the memory cells three-dimensional will increase the cost due to the complicated process. The thinning of the insulating film will drastically increase the leakage current due to the electron quantum effect when the thinning is excessive. The excessive thinning provides an adverse effect. The kinds of high dielectric materials applicable to the semiconductor process are limited, making it difficult to employ this technique.

For these reasons, the refresh interval tREF is becoming more difficult to increase year by year. In fact, while the tREF standard of a 64-Mbit SDRAM is 64 ms, the tREF standard of a 256-Mbit SDRAM also is 64 ms. As described above, to prevent the busy factor from being deteriorated, the refresh interval tREF must be doubled in a generational change. On this basis, the tREF of a 256-Mbit SDRAM should be 128 ms. It can be assumed from this that an attempt to increase the tREF is being limited.

The refresh interval is longer in excess of the tREF, which does not mean that all data cells cannot hold memory in parallel. The number of defective bits is gradually increased due to an error of several bits in one chip. However, an error of several bits can be hidden so that the refresh interval tREF can be substantially increased.

An SDRAM and a DDR SDRAM (DDR: Double Data Rate), representing currently major DRAM products, are referred to as an 8-pin chip in which 8 information input/output terminals exist. A 4-bit check bit is added to 8-bit information, and the ECC for correcting a 1-bit error in 12 bits (8+4 bits) is mounted to substantially increase the refresh interval tREF. The memory cells limiting the refresh interval tREF, whose memory holding time is short, exist relatively scatteringly. The possibility that the memory cells, whose memory holding time is short for 2 bits or more in the 12 bits, may exist is very low. As described above, the refresh interval tREF is easy to increase.

In accordance with the present invention as described above, 1) in a parallel test, not only an all bits coincidence state, but also a 1-bit non-coincidence state is decided as being acceptable. The parallel test which assumes that any defective bits will be relieved by the ECC can be conducted. 2) When executing the test for writing data directly from the outside into parity bits, data is allocated not only to the parity bits, but also to data bits to easily execute the test of the ECC decoder. 3) When executing the test for directly reading parity bits, the allocation of parity bits and data bits is the same as in the test writing data directly from outside into parity bits. At the check of parity bits, the operation can be carried out as a general DRAM. 4) In the arrangement in the memory array, parity bit areas are arranged in the areas in which the reading time is slower than the data areas. The access speed of the entire DRAM chip can be increased.

The invention which has been made by the present inventors has been specifically described above based on various embodiments. However, the present invention is not limited to the above-described embodiments, and various modifications can be made without departing from its purpose. For example, the ECC structure is not limited to a 8+4 method, and various methods such as 16+5, 32+6 or 64+7 can be considered. The basic concept of the invention is disclosed herein. In the parallel test, the same data is written into all bits. However, there is also the case in which a data pattern generated in a chip is written, and at reading, acceptance or rejection is determined in relation to the data pattern generated in the chip. Also in this case, the basic concept of the present invention in which 1-bit non-coincidence is determined as being acceptable is not changed and can be adopted. The present invention can be widely used in a semiconductor memory device in which writing and reading are performed like, a DRAM, a static RAM and a nonvolatile memory device, such as a flash memory, and a test method thereof.

The effects obtained by the representative features of the present invention will be simply described as follows. A semiconductor memory device has an ECC circuit capable of correcting, from an m-bit information code and an n-bit check code that have been stored in an information storing part, an error of the information code to x bits; and, there is a parallel test circuit for receiving an information code and a check code for the test with the same bits stored in the information storing part and for determining that a product with a defect with x+1 bits or more is defective. It is possible to obtain a semiconductor memory device mounting the ECC which enables an efficient test with high accuracy using a simplified structure.

A test method of a semiconductor memory device having an ECC circuit that is capable of correcting, from an m-bit information code and an n-bit check code stored in an information storing part, an error of the information code to x bits and a test circuit for receiving an information code and a check code in the information storing part, wherein an information code and a check code for the test with the same bits are stored in the information storing part, the stored information code and check code for the test are transmitted to the test circuit, and a product with a defect with x+1 bits or more for one piece of position information is determined to be as being defective. An efficient test is enabled with high accuracy using a simplified structure.

What we claim is:

1. A semiconductor device comprising:
a plurality of memory mats each of which includes a plurality of memory cells adapted to store an information code or an error correcting code for the information code;
an information storing part which includes the plurality of memory mats;
an error correcting circuit adapted to correct an error of the information code stored in the information storing part by using the error correcting code and adapted to correct the information code by one correction unit of a predetermined number of information codes;
wherein the semiconductor memory device is adapted to include a parallel test mode which activates and tests the plurality of memory mats simultaneously and which is a different function from a normal read or write function which activates one of the plurality of memory mats,
wherein the semiconductor memory device further includes parallel decision circuits which are adapted to be activated during the parallel test mode and which are respectively coupled between the error correcting circuit and each of the plurality of the memory mats, and
wherein the parallel test circuits are adapted to detect a one bit information code defect by the correction unit during the parallel test mode.

2. A semiconductor device according to claim 1,
wherein the parallel test circuits are adapted to decide that the one bit information code defect is an acceptance decision, and
wherein the parallel test circuits are adapted to decide that all bits information code coincidence is also an acceptance decision,

3. A semiconductor device according to claim 1,
wherein the parallel test circuits are adapted to decide that the one bit information code defect in all bits or a two bit information code defect in all bits which exists in a different correction unit are acceptance decisions.

4. A semiconductor device according to claim 2,
wherein the acceptance decisions assume relief in the error correction by the error correcting circuit.

5. A semiconductor device according to claim 3,
wherein the acceptance decisions assume relief in the error correction by the error correcting circuit.
